(19) United States
(12) Patent Application Publication
(10) Pub. No.: US 2015/0370834 A1
(43) Pub. Date: Dec. 24, 2015

(54) A SCHEMA GENERATION PROCESS AND SYSTEM

(71) Applicant: THE UNIVERSITY OF QUEENSLAND, St. Lucia, Queensland (AU)

(72) Inventor: Andrew SMITH, St. Lucia, Queensland (AU)

(21) Appl. No.: 14/765,704

(22) PCT Filed: Feb. 5, 2014
(86) PCT No.: PCT/AU2014/000081

§ 371 Date: Aug. 4, 2015

(30) Foreign Application Priority Data
Feb. 5, 2013 (AU) 2013900363

(51) Int. Cl. G06F 17/30

(52) U.S. Cl. CPC G06F 17/30297; G06F 17/30864; G06F 17/3053

(57) ABSTRACT

A computer implemented schema generation process, including: receiving one or more query terms; submitting the received query terms to a search engine; receiving, from the search engine, search results corresponding to the submitted query terms, said search results including a plurality of search records and respective weights, each of said search records including a plurality of corresponding record terms; and processing the search records and the respective weights to generate a multi-dimensional matrix or ‘schema’ including correlation scores for respective groupings of terms selected from the query terms and/or the record terms, each of the correlation scores being representative of the co-occurrence of the terms of the corresponding grouping of terms in the search records such that the correlation scores constitute measures of the relevance of the corresponding terms.

### TECHNICAL FIELD

The present invention relates to a schema generation process and system that analyse textual information to determine concepts expressed therein.

### BACKGROUND

In the current information age, extremely large quantities of semi-structured data are continuously being generated, including, inter alia:
(i) transactions: customer admin, sales, trading systems;
(ii) event logs: security monitors, systems monitors, web servers;
(iii) clinical monitoring: intensive care, long term therapy; and
(iv) media: twitter, email, newswire.

These types of data pose substantial analytical challenges for at least the following reasons:
(i) they include a large set of possible data terms;
(ii) the meaning of any term depends on the context at that time;
(iii) each record is sparse in that it only contains a small number of terms and a partial explanation of the situation (e.g., a tweet embedded in a Twitter thread);
(iv) simultaneous conversations can be interleaved—the correlation between records at similar times is unreliable;
(v) the data is noisy (e.g., spam);
(vi) the data is non-stationary (the statistical distributions of terms and term correlations change over time);
(vii) the relevant ‘stop words’ (e.g., the and is in English) vary from source to source, time to time, language to language, and context to context.

Such large quantities of textual data are difficult to analyse inductively due to the dynamic and complex nature of the systems involved. Current situational awareness technologies rely on forensic techniques and static models to identify emerging issues and trends; that is, “known” historical scenarios are used as the basis for modeling “unknown” emerging trends. A particular shortcoming of forensic approaches is that they fail to capture new and emerging (previously undefined) scenarios: the “unknown unknowns”.

It is desired to provide a schema generation process and system that alleviate one or more difficulties of the prior art, or that at least provide a useful alternative.

### SUMMARY

In accordance with some embodiments of the present invention, there is provided a computer implemented schema generation process, including:
receiving one or more query terms;
submitting the received query terms to a search engine;
receiving, from the search engine, search results corresponding to the submitted query terms, said search results including a plurality of search records and respective weights, each of said search records including a plurality of corresponding record terms; and
processing the search records and the respective weights to generate a multi-dimensional matrix or ‘schema’ including correlation scores for respective groupings of terms selected from the query terms and/or the record terms, each of the correlation scores being representative of the co-occurrence of the terms of the corresponding grouping of terms in the search records such that the correlation scores constitute measures of the relevance of the corresponding terms.

The process may include at least one of storing, outputting, or displaying data representing the schema.

The record terms may include terms representing metadata of the corresponding search records.

Also described herein is a schema generation process, including:
receiving one or more query terms;
submitting the received query terms to a search engine;
receiving, from the search engine, search results corresponding to the submitted query terms, said search results including a plurality of search records and respective weights, each of said search records including a plurality of corresponding record terms; and
processing the search records and the respective weights to generate a schema representing correlation scores for respective groupings of one or more of the query terms and/or one or more of the record terms, each correlation score being representative of the co-occurrence of a corresponding grouping of terms in the search records such that the correlation scores constitute measures of the relevance of corresponding terms.

The process may include at least one of storing, outputting, or displaying data representing the schema.

In some embodiments, the process includes selecting a subset of the terms of the schema based on corresponding correlation scores and submitting the selected terms as enhanced query terms to the search engine.

In some embodiments, the process includes:
receiving, from the search engine, second search results corresponding to the enhanced query terms, said second search results including a plurality of second search records and respective second weights, each of said second search records including a plurality of corresponding second record terms; and
processing the second search records, respective second weights and the schema to generate second correlation scores for respective groupings of the enhanced query terms and/or the second record terms, each second correlation score being representative of the co-occurrence of a corresponding grouping of terms in the second search records such that the second correlation scores constitute measures of the relevance of corresponding terms, and wherein each of the second groupings includes more terms than the groupings that were used to generate the schema.

In some embodiments, the process includes comparing said scores to a pre-determined threshold score, and selecting for processing only those terms whose scores are at least equal or greater than to the pre-determined threshold score.

In some embodiments, the process includes processing the scores to select a subset of the record terms for subsequent processing.

In some embodiments, the process includes processing the scores to select a subset of the query terms for subsequent processing.

In some embodiments, the process includes generating a concept tree representing relationships between said concepts.

In some embodiments, the process includes repeating at least some of the steps of the process to generate a plurality of schemas for respective different times, and processing the plurality of schemas to determine changes in the relevance of the terms over time. The process may include at least one of storing, outputting, or displaying data representing the changes.

In some embodiments, the process includes generating a tree structure representing relationships between said terms.

In some embodiments, the terms are associated with one or more corresponding concepts, and the correlation scores constitute measures of the relevance of said concepts expressed in the search records.

In some embodiments, the search records represent natural language. In some embodiments, the search records represent transaction logs.

In some embodiments, the groupings are pairs of terms.

In accordance with some embodiments of the present invention, there is provided a computer-readable storage medium having stored thereon executable instructions that, when executed by at least one processor of a computing system, cause the at least one processor to execute any one of the above processes.

In accordance with some embodiments of the present invention, there is provided a schema generation system configured to execute any one of the above processes.

In accordance with some embodiments of the present invention, there is provided a schema generation system, including a schema generation component configured to:
receive one or more query terms;
submit the received query terms to a search engine;
receive, from the search engine, search results corresponding to the submitted query terms, said search results including a plurality of search records and respective weights, each of said search records including a plurality of corresponding record terms;
process the search records and the respective weights to generate a multi-dimensional matrix or ‘schema’ including correlation scores for respective groupings of terms selected from the query terms and/or the record terms, each of the correlation scores being representative of the co-occurrence of the terms of the corresponding grouping of terms in the search records such that the correlation scores constitute measures of the relevance of the corresponding terms.

The record terms may include terms representing metadata of the corresponding search records.

In some embodiments, the schema generation component is configured to compare said scores to a pre-determined threshold score, and select for processing only those terms whose scores are at least equal to or greater than the pre-determined threshold score.

In some embodiments, the schema generation component is configured to process the scores to select a subset of the record terms and/or the query terms for subsequent processing.

Also described herein is a schema generation system, including a schema generation component configured to:
receive one or more query terms;
submit the received query terms to a search engine;
receive, from the search engine, search results corresponding to the submitted query terms, said search results including a plurality of search records and respective weights, each of said search records including a plurality of corresponding record terms; and
process the search records and the respective weights to generate a schema representing correlation scores for respective groupings of one or more of the query terms and/or one or more of the record terms, each correlation score being based on the co-occurrence of a corresponding grouping of terms in the search records such that the correlation scores constitute measures of the relevance of corresponding terms.

### BRIEF DESCRIPTION OF THE DRAWINGS

Some embodiments of the present invention are hereinafter described, by way of example only, with reference to the accompanying drawings, wherein:

FIG. 1 is a flow diagram of a schema generation process;

FIG. 2 is a block diagram of a schema generation system that executes the schema generation process of FIG. 1;

FIGS. 3 and 4 are histograms showing the normalised number of search hits resulting from the search queries “M1” and “Lindberg shipment”, respectively, as a function of date in an 8 week period in 2003, illustrating the temporal trend of newspaper coverage through the course of the time period before and after the invasion of Iraq; and

FIG. 5 is a graphical representation of a concept tree generated from the schema generated by the process of FIG. 1.

### DETAILED DESCRIPTION

Described herein are schema generation processes and systems that are used to process large numbers of discrete items of textual data in order to generate at least one multi-dimensional matrix or ‘schema’ identifying common terms in those items of textual data and relationships between those terms within the data, without requiring any prior knowledge or identification of those terms or relationships.

The textual data items (which for convenience are also referred to herein as “records”) typically include terms such as words and any metadata associated with those terms and may be relatively small (e.g., sentences, tweets, and the like). As the terms and their metadata are effectively treated equivalently by the described processes, for convenience, the word “terms” is to be construed broadly in this specification to include metadata terms (i.e., textual terms representing metadata) associated with the non-metadata or ‘content’ terms. The system and process can be applied to analyse essentially any type of textual data, including not only written natural language (e.g., tweets, short messages, emails, comments, blog entries, articles, reports, stories, books, and collections of same), but also system logs, transaction logs, etc. Common, specified, or otherwise salient terms can be identified and associations of those terms with other terms and/or metadata can be automatically determined. For example, where the items of textual data are in the form of written natural language, such terms can be indicative of particular concepts, themes, or sentiments of interest or significance, whether known in advance or ‘discovered’ by processing the data. Irrespective of the origin or type of textual data processed, the power of the described system and processes is particularly evident where the data records include terms from a very large or open vocabulary.

The schema generation processes and systems described herein discover latent ontologies in the textual data items, which allows them be used to monitor emerging multiple scenarios from temporally changing semi-structured (‘content’ terms and metadata terms) data streams, enabling mapping of concepts through time, and early identification of emerging trends. The schema generation processes and systems can be used to automatically discover and display a dynamic schema to reflect the multiple scenarios that emerge from real-world system logs and text, and to detect and contextualize critical changes at an early stage.

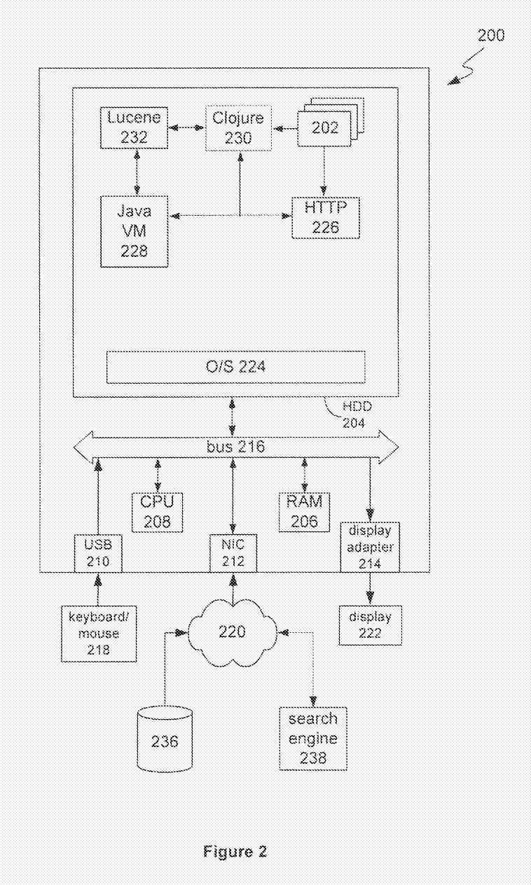

In the described embodiment, the schema generation system is a standard computer system such as an Intel IA-32 based computer system 200, as shown in FIG. 2, and the schema generation processes executed by the system 200 are implemented in the form of programming instructions of one or more software modules or components 202 stored on tangible and non-volatile (e.g., solid-state or hard disk) storage 204 associated with the computer system 200, as shown in FIG. 2. However, it will be apparent that the processes could alternatively be implemented, either in part or in their entirety, in the form of one or more dedicated hardware components, such as application-specific integrated circuits (ASICs), and/or in the form of configuration data for configurable hardware components such as field programmable gate arrays (FPGAs), for example.

As shown in FIG. 2, the system 200 includes standard computer components, including random access memory (RAM) 206, at least one processor 208, and external interfaces 210, 212, 214, all interconnected by a bus 216. The external interfaces include universal serial bus (USB) interfaces 210, at least one of which is connected to a keyboard 218 and pointing device such as a mouse, a network interface connector (NIC) 212 which connects the system 200 to a communications network 220 such as the Internet, via which information resources 236 providing the textual data items and (if not local) search engine 238 to process search queries can be accessed by the system 200.

The system 200 also includes a display adapter 214, which is connected to a display device such as an LCD panel display 222, and a number of standard software modules 226 to 232, including an operating system 224 such as Linux or Microsoft Windows, web container software 226 such as Jetty, available at http://www.eclipse.org/jetty/, a Java virtual machine 228, the Clojure module (JAR file) 230 to support the Clojure dynamic programming language, available from http://clojure.org, and the Apache Lucene search engine library 232. The Java virtual machine 228 also provides the ability to store data representing the schema generated by the system on the non-volatile storage 204 of the system 200 and/or in the ‘cloud’ via the Internet 220.

In another embodiment (not shown), the system may include scripting language support 228 such as PHP, available at http://www.php.net, or Microsoft ASP, and structured query language (SQL) support 230 such as MySQL, available from http://www.mysql.com, which allows data to be stored in and retrieved from an SQL database 232, including data representing the schema generated by the system.

The schema generated by the described processes and systems can be considered as being analogous to a human memory system, and to Schema Theory, as described in Bartlett, F. C., Remembering: A Study in Experimental and Social Psychology, Cambridge University Press (1932), which is a conceptualisation of the way in which humans appear to respond cognitively to events in everyday life.

Schema Theory can be summarised as follows:
1. A person encounters many events in their perceptual experience of the world.
2. Any given event, in its raw form, is a fragmentary trace of sensory data—sounds, image elements, etc. An event can be broken down into a direct focus of attention (the cue), such as a red traffic light, and the context, such as driving a car down a street.
3. For a person to respond systematically to any event, each event must be interpreted using a cognitive framework, which is referred to as a schema. The schema in this case needs to provide a template of what it means to encounter the cue (the red light), within the context (driving the car). Seeing a red light while seated in a café (a different context), must have a different interpretation.
4. For a person to adapt to, and learn from, a changing environment, the schema is derived ad hoc from a memory of previous events.
5. One way a schema can be used is to retrieve similar events from past experience, to provide specific examples of strategies and outcomes, and a richer back-story. This is often is referred to as recollection from episodic memory. The person remembers braking the vehicle yesterday after seeing the red light.
6. Another way the schema could be used is to allow reasoning within the schema itself. The schema becomes an ad hoc set of rules to be utilised without needing to recollect particular events. Experienced drivers just know how to respond to a red light, but would struggle to tell you when they learned, or even the last time they did it. This is often is referred to as recall from semantic memory.
7. Reasoning within the schema itself has the advantage that indirect connections can be made. An unsubtle example is that you may have seen another car have a bad accident at a traffic light. Even though you have never experienced this sort of event yourself, your schema may indicate that if you failed to brake at a red light, you too could experience an accident. A schema can allow ad hoc integration and generalisation of experience.

In part, the described processes are also based on the Matrix Memory Model theory of human memory described in Humphreys, M. S, Bain, J. D, & Pike, R.: Different Ways to Cue a Coherent Memory System: A Theory for Episodic, Semantic, and Procedural Tasks, Psychological Review, 96(2), 208-233 (1989), which unified episodic and semantic memory functions and accounted for many results from human cognitive experimentation.

Matrix Memory constructs a composite memory trace from cue, result and context components of experiences. This trace can be probed in multiple ways, corresponding to different memory styles, such as episodic and semantic memory. By this means, a cue term will retrieve different response term vectors if either the context vector changes, or the memory changes.

For the purpose of testing the Matrix Memory model as a possible solution, the inventor reduced the Matrix Memory model to its simplest form, using a memory structure based on a three-dimensional term-by-term-by-term co-occurrence matrix (effectively aggregating terms corresponding to cue, result and context from experience). In other words, the matrix stores how often each term has been observed to appear together with a second term and with a third term. Each term is thus represented by a vector, and these vectors are orthogonal for different terms. The context column vector is multiplied into the cue row vector (using a matrix product operation), and the result is multiplied into the 3D memory matrix (using an inner product operation). If there are multiple terms in a cue or context, then the vector is the sum of the individual term vectors, as follows:

| [ cue terms ] x [ context vector ] | |
|---|---|
| . [ term by term by term matrix ] | |
| = [ response vector ] | (1) |

For example:

( [ red ] + [ light ] ) x ( [ driving ] + [ car ] + [ street ] )
. [ term co-occurrence matrix ]
= [ red ] + [ light ] + [ brake ] + [ stop ] + [ car ] + [ line ]

A significant feature of this model is that the specificity of the response can be controlled by the specificity of the context. A very precise context can retrieve a very specific episode from memory, whereas an abstract context will retrieve a more general semantic pattern corresponding to the sum of all the contexts that share any similarity with the abstract context. This can be thought of as the ‘car keys’ memory problem: if you lose your car keys, it is often very difficult to retrieve their exact location from memory with the bald query “where are the car keys?”. However, the task can be made easier if the query is made more specific, for example: “where was I the last time I must have had my car keys?”.

If the data has a large vocabulary of terms, it quickly becomes infeasible to store the rank-3 co-occurrence matrix in memory. Worse still, if the process were to store higher order correlations between the observed terms, this would require exponentially more memory.

To overcome this difficulty, the inventor observed that the term records themselves for the observed events actually contain all the available correlation information of any order. Accordingly, Equation (1) is expanded to expose the event records dimension, and a non-linear filter is added to select only those events with higher order combinations of terms, such as Boolean combinations of cue terms:

| [ cue terms ] x [ context vector ] | |
|---|---|
| . [ term by term by event matrix ] | |
| x non-linear filter | |
| x [ event by term matrix ] | |
| = [ response vector ] | (2) |

The first four factors in Equation (2) can be replaced by a text search engine. In general, search engine APIs return weighted lists of text records in response to simple or complex queries such as Boolean compound filters and term vectors, and embodiments of the present invention can use any search engine that also returns term document frequencies and total document counts, as will be apparent from the following description. Examples of suitable search engines include the open source Lucene, and the ElasticSearch engine built on top of Lucene, albeit with minor modifications to provide access to the term and document statistics returned by Lucene.

Consequently, the process can be summarised as:

[ cue (Boolean filter) ] x [ context (term vector query) ]
→ search engine
→ [ events by terms matrix ]
→ term correlation metric
→ [ term by term schema ]

When expressed in this manner, the cue matrix is a matrix of Boolean qualifiers that are applied to corresponding terms from the context (term vector query) array. More generally, the cue and context matrices in the above can be replaced with any suitable input query for a search engine.

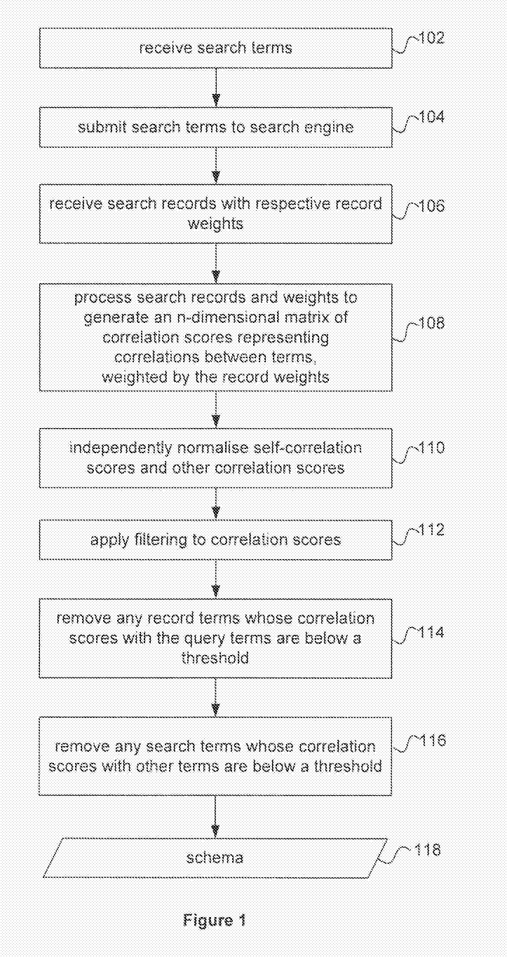

Thus in the described embodiments, as shown in the flow diagram of FIG. 1, a search query is received at step 102 and submitted at step 104 to a search engine 238 via a corresponding API. At step 106, the search engine 232 (or 238, as the case may be) returns weighted event records that are relevant to the cue and the context. The returned records themselves provide correlation information between terms in these records. Accordingly, the weighted event (i.e., search result) records are processed at step 108 to generate a term correlation matrix referred to herein as a “schema” by analogy with Bartlett's Schema Theory as described above.

In the described embodiments, the generated schema is two-dimensional. However, it will be apparent to those skilled in the art that the process can be extended to generate any desired (multi) dimensionality of schema. The process is coded as follows:

# total_event_count is the total number of event records in the
data.
#
# events_list is a list of the event record identifiers returned by
# the search engine.
#
# Function words_in_event(event) returns a list of the words
# which appear in this event.
#
# Function weight(event) returns the normalised relevance score
# returned by the search engine for this event.
#
# Function total_word_count(word) returns one of two slightly
# different possible values in respective embodiments or selectable
# by the user: either the total number of events
# containing this word, or the total number of times this word
# appears in the whole data set. The latter statistic is more
# aggressive at down ranking stop words.
#
# Function word_count_in_event(word, event) returns the number
# of times word appears in event.
index = −0.5 * (1 + exp(−1 * (total_event_count**2) * 1E−8));
threshold = 9**index;
foreach event (events_list){
event_words_list = words_in_event(event);
foreach word1 (event_words_list){
activation = weight(event)
* sqrt(total_event_count)
* total_word_count(word1)**index
* word_count_in_event(word1, event);
### Stop word threshold #####
next word1 if activation < threshold;
schema(word1, word1) = 0 if not defined;
schema (word1, word1) += activation;
foreach word2 (event_words_list){
if (word1 ne word2){
pair_activation = activation
* ( sqrt(total_event_count)
/ sqrt(total_word_count(word2)) )
* word_count_in_event(word2, event);
schema(word1, word2) = 0 if not defined;
schema(word1, word2) + = pair_activation;
}
}
}
}

The resulting schema is a two-dimensional matrix of correlation or ‘activation’ scores or metrics representing co-occurrence correlations between all possible pairs of terms (including the search/query terms and all of the terms in the set of retrieved records), except for those pairs of terms whose correlation scores in all of the records is below a pre-determined stop word threshold value, which in other embodiments can be determined in ways other than that described above. Conventionally, this matrix can also be thought of as a weighted symmetric reflexive network. The self and pair activation metrics are derived initially from the Bayes Factor measure of correlation that is the degree of correlation between two variables being the ratio of the joint probability to the product of the marginal probabilities. The frequentist approximation is used to estimate probabilities from observed frequencies, which the inventor has found works well due to the large size of most relevant data sets. Bayesian priors are not used due to the risk of inappropriate estimates for them.

Returning to the flow diagram of FIG. 1, the generated schema scores can then be normalised at step 110 using an appropriate measure, such as the Euclidean norm. In the described embodiments, the vector of on-diagonal values (self activations) and the matrix of off-diagonal values (cross activations) are separated, normalised independently, and then recombined to provide a single normalised matrix, however this need not be the case in other embodiments. The elements of the schema can then be thresholded as desired at step 112. That is, any combinations of terms whose scores are less than a corresponding threshold value are removed from the matrix or in other embodiments are otherwise not used in subsequent steps of the process. In the described embodiment, different threshold scores are used for self-activation scores and cross-activation scores, but this need not be the case in other embodiments.

Various forms of more advanced filtering can also be applied to the schema, if desired. In particular, given knowledge of the original cue and context terms (or, equivalently, the search engine query term(s)), other discovered terms that are not sufficiently linked in the schema to the original query terms according to one or more specified criteria can be removed at step 114 to enhance the relevancy of the schema. There are many different criteria that can be used to determine whether or not terms are sufficiently ‘linked’ for this purpose, including, for example, that a term under consideration must be strongly correlated with a specified subset of the search terms, or alternatively with a specified fraction of the total set of search terms. Other useful criteria will be apparent to those skilled in the art in light of this disclosure.

Once such a filter has been applied to reduce the number of ‘discovered’ terms in the retrieved search records, any original query terms from the schema that no longer link to sufficient remaining terms can be removed at step 116 to provide a final schema 118. This has the effect of removing initial context (i.e., search query) term suggestions that do not in fact have any significant correlation, either directly or indirectly, with the other terms in the list of context items. As one example of how this can be used, this form of filtering is relevant to the use of a list of context terms as a measure of sentiment. Often a few such user-selected terms do not in fact share a similar sentiment with the other sentiment context terms in the data in question. This form of filtering acts to remove such outlier context terms.

The term groupings and associated scores in the schema 118 can then be used to generate a concept tree using a standard ‘spanning forest’ method known to those skilled in the art, such as Kruskal's algorithm, for example.

The schema 118 can also be effectively partitioned into layers based on the various type classes of words and tags present in the schema 118. For example, if author tags are present in the retrieved records, then a schema 118 can contain author tags correlated with the query. The activation values of the schema 118 associated with combinations of the author tags can be used to show how the authors correlate with each other, or what other terms (such as topical words) correlate with each of the authors. This information can be used to determine relationships between authors in respect of a particular topic and/or other criteria, and hence to generate a visual representation of those relationships, referred to in the art as a ‘community map’. For example, a community map can be generated to represent discourse relationships and sentiments between authors in the topic space defined by a particular query. In general, any specified type of terms of the schema 118 can be regarded as a ‘layer’ and independently analysed, including terms defined as being associated with one or more specified sentiments, time and date tags, names, etc. Many other useful types of terms will be apparent to those skilled in the art in light of this disclosure.

In some embodiments, terms of the schema 118 are clustered into topical layers using the Newman-Girvan clustering method described in Newman, M. E., Analysis of weighted networks, Physical Review E, 70(5), 056131 (2004). The Newman-Girvan clustering method is well suited for this purpose because it is nonparametric (i.e., there is no requirement to set a parameter that determines the resulting number of clusters) and it is well defined for weighted networks such as the schema 118 generated by the schema generation process and system described herein.

An important use of the schema 118, or any ‘layer’ of the schema 118, is to retrieve and classify relevant event records. The schema generation system can be used to perform extended retrieval of relevant event records by taking the diagonal elements of the generated schema 118, i.e. a list of all the terms in the schema 118 (and optionally also their self-activation values/scores), and resubmitting this list to the search engine 232 (or 238) as an expanded term vector query. The presence of new related terms in this list, compared to the original query, causes recall of the original query to be increased dramatically. Once the search engine 232 (or 238) has returned the expanded set of records, the schema 118 can be used to enhance precision and relevancy by scoring each of the expanded records based on second (or higher) order term correlations as well as first order correlations, using the same schema 118.

Classification of the records is achieved by summing the scores of the schema 118 that correspond to terms and term pairs in each event record. In the described embodiment, this sum is multiplied by the number of schema terms present in the record, divided by the minimum of the number of terms in the record or the query. The final record weights are then normalised, for example using the Euclidean norm. This process can be used to classify the records based on the whole schema 118, or any layer thereof, such as sentiment, for example. The final result of the classification is, for each record, a total score that represents the relevance of that record to the topic, and a corresponding set of schema terms found in the record, each such term being assigned a corresponding weight or score representing how much that terms links the record to the schema 118. Optionally, additional scores can be generated indicating the relevancy of the term or the entire record to one or more specified layers, such as positive sentiment, for example.

The schema generation system and processes described herein have many applications for real-time analysis of many different forms of rich data sources, including social media, defense and intelligence data, and including, for example:
(i) searching: e.g., internet browsing, enterprise search tools;
(ii) transactions: e.g., customer admin, sales, trading systems;
(iii) event logs: e.g., security monitors, systems monitors, web servers;
(iv) clinical monitoring: e.g., intensive care, long term therapy; and
(v) social media and media analysis: e.g., twitter, email, newswire.

The described schema generation processes offer significant advantages over existing semantic indexing systems, including:
(i) the ability to distinguish noise from non-noise without the use of pre-defined rules or stop words;
(ii) faster processing time for extracting concepts; and
(iii) higher search success rates compared to keyword searching technology.

### EXAMPLE I

The schema generation process described above was used to assess the relationships between the single term “M1” and other terms in a set of articles published in “The Australian” newspaper in an 8 week period from 12 Feb. to 28 Apr. 2003, which spans the 2003 invasion of Iraq.

The term “M1” was submitted to the ElasticSearch API (with minor modifications as described above) and the search records and respective weights returned by the API were then processed as described above to generate a two-dimensional matrix of scores for respective pairs of terms, including the search term “M1” and the terms in the search records returned by the API. For the purposes of illustration, the first three rows of the resulting matrix are shown below, represented as respective paragraphs. The first paragraph below thus represents the scores generated for pairs of terms including the search term “M1”, and respectively the search record terms “Dynamics”, “Abrams”, “manufactured”, and so on, with respective raw scores of 43424, 38839, 20860, etc. shown in square parentheses. Similarly, the second paragraph (i.e., row) identifies each term paired with the term “Dynamics” and the respective scores, the third paragraph (i.e., row) identifies each term paired with the term “Abrams” and the respective scores, and so on.

M1 [461] ==>
Dynamics [43424], Abrams [38839], manufactured [20860], Industries
[18803], litres [16412], Bradley [15042], mile [14750], Doc_{——}1059
[13295], Doc_{——}1403 [12713], rolling [12043], uses [10856], fuel
[7237], carrying [7075], tank [6894], vehicles [5701], tanks
[4602], United [3997], southern [3980], battle [3926], ground
[3644], On [3529], fighting [3487], Defence [3327], General [3015],
7 [2578], while [2442], 5 [2400], troops [1820], Date_{——}27_3_2003
[1658], into [1623], Date_{——}21_3_2003 [1290], from [983], are [927],
by [893], Iraq [818], MoY_{——}3 [754], The [645], DoW_{——}thu [607],
Year_{——}2003 [499], a [481], DoW_{——}fri [457], of [411], the [348],
Dynamics [188] ==>
M1 [43424], manufactured [17032], Abrams [15856], Industries
[15352], Bradley [12282], Doc_{——}1059 [10856], rolling [9833],
carrying [5777], vehicles [4655], tanks [3758], United [3263],
southern [3250], battle [3205], ground [2975], On [2882], fighting
[2847], Defence [2716], General [2462], while [1994], troops
[1486], into [1325], Date_{——}21_3_2003 [1053], from [802], are [757],
by [729], Iraq [668], DoW_{——}fri [373], MoY_{——}3 [308], the [284],
Year_{——}2003 [203],
Abrams [168] ==>
M1 [38839], Dynamics [15856], manufactured [7617], Industries
[6865], litres [5993], Bradley [5492], mile [5386], Doc_{——}1059
[4854], Doc_{——}1403 [4642], rolling [4397], uses [3964], fuel [2642],
carrying [2583], tank [2517], vehicles [2082], tanks [1680], United
[1459], southern [1453], battle [1433], ground [1330], On [1288],
fighting [1273], Defence [1214], General [1101], 7 [941], while
[891], 5 [876], troops [664], Date_{——}27_3_2003 [605], into [592],
Date_{——}21_3_2003 [471], from [359], are [338], by [326], Iraq [299],
MoY_{——}3 [275], The [235], DoW_{——}thu [221], Year_{——}2003 [182], a
[175],
DoW_{——}fri [166], of [150], the [127],

As described above, the self-activation scores and the other scores were then normalised separately using a Euclidian norm, and the resulting normalised scores were then recombined to provide a normalised matrix, of which the first three rows are as follows:

M1 [0.8121] ==>
M1 [0.8121], Dynamics [0.34488], Abrams [0.30847], manufactured
[0.16567], Industries [0.14934], litres [0.13035], Bradley
[0.11947], mile [0.11715], Doc_{——}1059 [0.10559], Doc_{——}1403
[0.10097], rolling [0.09565], uses [0.08622], fuel [0.05748],
carrying [0.05619], tank [0.05476], vehicles [0.04528], tanks
[0.03655], United [0.03174], southern [0.03161], battle [0.03118],
ground [0.02894], On [0.02803], fighting [0.0277], Defence
[0.02642], General [0.02395], 7 [0.02047], while [0.0194], 5
[0.01906], troops [0.01445], Date_{——}27_3_2003 [0.01317], into
[0.01289], Date_{——}21_3_2003 [0.01024], from [0.00781], are
[0.00736], by [0.00709], Iraq [0.0065], MoY_{——}3 [0.00599], The
[0.00512], DoW_{——}thu [0.00482], Year_{——}2003 [0.00396], a [0.00382],
DoW_{——}fri [0.00363], of [0.00326], the [0.00276],
Dynamics [0.33154] ==>
M1 [0.34488], Dynamics [0.33154], manufactured [0.13527], Abrams
[0.12593], Industries [0.12193], Bradley [0.09754], Doc_{——}1059
[0.08622], rolling [0.0781], carrying [0.04588], vehicles
[0.03697], tanks [0.02984], United [0.02592], southern [0.02581],
battle [0.02546], ground [0.02363], On [0.02289], fighting
[0.02261], Defence [0.02157], General [0.01955], while [0.01584],
troops [0.0118], into [0.01053], Date_{——}21_3_2003 [0.00836], from
[0.00637], are [0.00601], by [0.00579], Iraq [0.00531], DoW_{——}fri
[0.00296], MoY_{——}3 [0.00244], the [0.00225], Year_{——}2003 [0.00161],
Abrams [0.29654] ==>
M1 [0.30847], Abrams [0.29654], Dynamics [0.12593], manufactured
[0.06049], Industries [0.05453], litres [0.04759], Bradley
[0.04362], mile [0.04277], Doc_{——}1059 [0.03855], Doc_{——}1403
[0.03686], rolling [0.03492], uses [0.03148], fuel [0.02098],
carrying [0.02051], tank [0.01999], vehicles [0.01653], tanks
[0.01334], United [0.01159], southern [0.01154], battle [0.01138],
ground [0.01056], On [0.01023], fighting [0.01011], Defence
[0.00964], General [0.00874], 7 [0.00747], while [0.00708], 5
[0.00696], troops [0.00527], Date_{——}27_3_2003 [0.0048], into
[0.0047], Date_{——}21_3_2003 [0.00374], from [0.00285], are [0.00269],
by [0.00259], Iraq [0.00237], MoY_{——}3 [0.00218], The [0.00187],
DoW_{——}thu [0.00176], Year_{——}2003 [0.00144], a [0.00139], DoW_{——}fri
[0.00132], of [0.00119], the [0.00101],

The normalised matrix was then processed to generate the concept tree shown below. In this simple example, the concept tree can be generated by simply listing the terms in decreasing order of score when paired with the search term. However, in general the concept tree is generated from the schema using a standard ‘spanning forest’ method, such as Kruskal's algorithm:

| | |
|---|---|
| M1 | −> Dynamics |
| | −> Abrams |
| | −> manufactured |
| | −> Industries |
| | −> litres |
| | −> Bradley |
| | −> mile |
| | −> rolling |
| | −> uses |
| | −> fuel |
| | −> carrying |
| | −> tank |
| | −> vehicles |
| | −> tanks |
| | −> United |
| | −> southern |
| | −> battle |
| | −> ground |
| | −> On |
| | −> fighting |
| | −> Defence |
| | −> General |
| | −> 7 |
| | −> while |
| | −> 5 |
| | −> troops |
| | −> into |

The discovered terms were then used as enhanced query terms and re-submitted to the search engine, retrieving sixty-two records of which the first three are shown below, together with the total weight of each record and the relative contributions of the terms in each record to the schema:

(0.9638) => On the ground the M1 Abrams battle tanks rolling into
southern Iraq are manufactured by General Dynamics while the
Bradley fighting vehicles carrying the troops are from United
Defence Industries Doc_{——}1059 DoW_{——}fri Date_{——}21_3_2003
MoY_{——}3
Year_{——}2003 [Fri Mar 21 00:00:00 2003, M1−> 2.5258, Dynamics−>
1.6681, Abrams−> 1.1181, manufactured−> 0.8716, Industries−>
0.7914, Bradley−> 0.6416, Doc_{——}1059−> 0.5705, rolling−> 0.5191,
carrying−> 0.3102, vehicles−> 0.2511, tanks−> 0.2035, United−>
0.1771, southern−> 0.1763, battle−> 0.1739, ground−> 0.1616, On−>
0.1566, fighting−> 0.1547, Defence−> 0.1477, General−> 0.134,
while−> 0.1087, troops−> 0.0812, into−> 0.0725, Date_{——}21_3_2003−>
0.0576]
(0.2618) => The M1 Abrams tank uses 7 5 litres of fuel a mile
Doc_{——}1403 DoW_{——}thu Date_{——}27_3_2003 MoY_{——}3 Year_{——}2003
[Thu Mar 27
00:00:00 2003, M1−> 1.7202, Abrams−> 0.8239, litres−> 0.448, mile−>
0.4063, Doc_{——}1403−> 0.3541, uses−> 0.3053, fuel−> 0.2075, tank−>
0.198, 7−> 0.0757, 5−> 0.0705, Date_{——}27_3_2003−> 0.0489]
(0.0175) => The parachute drop near the northern town of Bashur by
the 173rd Airborne Division based in Italy is believed to have been
the biggest battlefield assault by US paratroopers since Panama in
1989 and will be followed by Abrams tanks and Bradley fighting
vehicles of the 1st Infantry Division Doc_1405 DoW_{——}thu
Date_{——}27_3_2003 MoY_{——}3 Year_{——}2003 [Thu Mar 27 00:00:00
2003,
Abrams−> 0.3849, Bradley−> 0.1894, vehicles−> 0.0797, tanks−>
0.0651, fighting−> 0.0499, Date_{——}27_3_2003−> 0.0174]

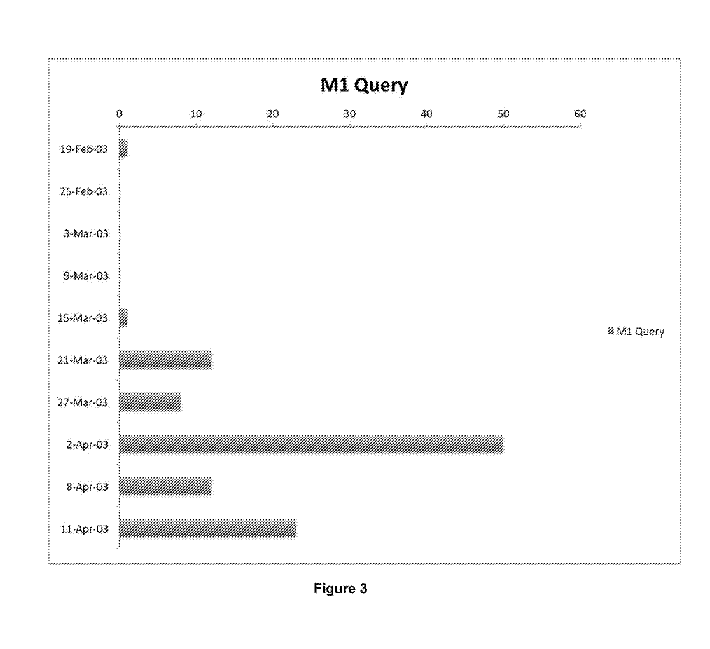

Using the date metadata associated with the search records, a time-based histogram of final search hits relevant to the schema generated from the single query term “M1” was generated, as shown in FIG. 3. This histogram shows the trend of coverage of US armoured vehicles through the course of the time period before and after the invasion of Iraq. The horizontal axis units are normalised hit counts.

### EXAMPLE II

As a second example, the query terms “Lindberg shipment” were used to search the same repository of newspaper articles from 2003 described above.

The first three rows of the resulting normalised schema (before filtering) were as follows:

shipment [0.64103] ==>
shipment [0.64103], A162 [0.13427], US96 [0.13427], Nokia
[0.11393], contaminated [0.08527], Hewlett [0.07206], Packard
[0.07206], plated [0.06713], Doc_{——}300 [0.06298], Motorola [0.0609],
inspected [0.05371], Doc_{——}2147 [0.04986], Sony [0.04858], commandos
[0.04003], detain [0.03876], protected [0.0376], Georgia [0.03724],
intercepted [0.03435], factory [0.03289], grade [0.0316], owed
[0.0308], grain [0.03045], 1995 [0.02992], Fort [0.0293], Jordanian
[0.02723], AWB [0.02723], team [0.02531], Doc_{——}2445 [0.02493],
Doc_{——}1088 [0.02493], clients [0.02457], Doc_{——}2522 [0.02325],
survive [0.02213], looted [0.02178], Stewart [0.02047], virus
[0.01983], August [0.01898], Doc_{——}860 [0.01848], partly [0.01719],
headed [0.0155], bound [0.0151], parts [0.01502], ship [0.01456],
November [0.01441], debt [0.01423], concerned [0.01246], wheat
[0.01225], 48 [0.01215], insurance [0.01215], paid [0.01177], board
[0.01172], remember [0.01159], Date_{——}24_2_2003 [0.01142],
authorities [0.01134], An [0.01117], port [0.01082], follow
[0.01071], base [0.00961], Some [0.00939], gold [0.00926], concerns
[0.00897], missile [0.00834], member [0.00829], by [0.00797],
spokesman [0.00775], believed [0.00726], Date_{——}28_4_2003 [0.00716],
His [0.00704], high [0.00668], officials [0.00636], a [0.00636],
taken [0.00611], including [0.00597], was [0.00592], decision
[0.00584], government [0.00564], of [0.00558], But [0.00504], Gulf
[0.00487], had [0.00483], may [0.00477], days [0.00472], million
[0.00465], been [0.00458], War [0.00434], Date_{——}24_4_2003
[0.00411], the [0.0041], for [0.0039], still [0.00389], before
[0.00379], DoW_mon [0.00374], because [0.00363], and [0.00357], In
[0.00354], weapons [0.00342], Date_{——}18_3_2003 [0.00341], Iraq
[0.00321], last [0.00301], Year_{——}2003 [0.00294], military
[0.00289], its [0.00263], MoY_{——}2 [0.00241], Iraqi [0.00232], The
[0.0023], Date_{——}21_3_2003 [0.0023], they [0.00212], from [0.0021],
were [0.00206], not [0.00201], his [0.00195], an [0.00189],
Australian [0.00183], said [0.00181], it [0.0018], in [0.00175],
have [0.00162], war [0.00156], MoY_{——}4 [0.00155], to [0.00152],
MoY_{——}3 [0.00148], US [0.00141], DoW_{——}tue [0.00132], on [0.00127],
DoW_{——}thu [0.00108], DoW_{——}fri [0.00081],
Lindberg [0.51758] ==>
Lindberg [0.51758], Doc_{——}979 [0.18285], AWB [0.10244], customer
[0.07691], cargo [0.07486], actively [0.05768], associated
[0.04615], farmers [0.0408], protected [0.03916], managing
[0.03498], managed [0.03083], contracts [0.02954], hostilities
[0.02916], wheat [0.02553], Andrew [0.02459], ensure [0.02225],
different [0.01989], period [0.01963], interests [0.01939],
director [0.01804], risk [0.01791], company [0.01701],
Date_{——}20_3_2003 [0.01651], found [0.01503], hard [0.01448], fight
[0.01434], post [0.01366], might [0.01163], said [0.01052], Mr
[0.0102], very [0.00878], DoW_{——}thu [0.00752], all [0.00647], its
[0.00534], MoY_{——}3 [0.00467], the [0.00432], will [0.00389],
Australian [0.00382], be [0.00356], with [0.00348], are [0.00344],
Year_{——}2003 [0.00309], for [0.00296], a [0.00208], in [0.00183], to
[0.00158],
A162 [0.19721] ==>
US96 [0.35526], A162 [0.19721], shipment [0.13427], owed [0.0815],
Doc_{——}1088 [0.06597], partly [0.04548], debt [0.03765], insurance
[0.03216], paid [0.03115], remember [0.03068], taken [0.01618],
Gulf [0.01288], million [0.0123], War [0.0115], still [0.01031],
before [0.01004], But [0.00666], Date_{——}21_3_2003 [0.00609], they
[0.00562], by [0.00421], war [0.00413], Iraq [0.00386], on
[0.00338], a [0.00227], DoW_{——}fri [0.00215], and [0.00214], MoY_{——}3
[0.00178], the [0.00164], Year_{——}2003 [0.00117],

The normalised schema was then subjected to the following filtering and thresholding rules for Term List Query:
1. Remove any term not related to any other terms.
2. Designate as relevant any non-query term that is related to a number of query terms that is greater than or equal to the square root of the total number of query terms.
3. Designate any query term as relevant.
4. Designate as kept any relevant term with a self activation greater than or equal to 0.025.
5. If any pair of relevant terms have a cross-activation greater than 0.01, then designate both terms as kept.
6. If any term is not kept, remove the term and all relationships involving that term from the schema.
7. Any relationship with a cross activation less than 0. 0005 is deleted.
8. Any query term that is now related to a number of other terms less than the square root of the number of terms in the schema is deleted.

The final schema resulting from the application of the above filtering and thresholding rules was as follows:

shipment ==>
shipment, protected, AWB, wheat,
Lindberg ==>
Lindberg, AWB, protected, wheat,
AWB ==>
AWB, Lindberg, shipment, protected, wheat,
protected ==>
protected, Lindberg, shipment, AWB, wheat,
wheat ==>
wheat, Lindberg, shipment, AWB, protected,
This final schema was processed to generate the following Concept
Tree:

| | |
|---|---|
| shipment −> protected −> Lindberg | −> AWB |
| | −> wheat |

The schema was also used to expand the query terms for re-submission to the search engine API, expanding the single term “Lindberg” to the four terms “Lindberg AWB protected wheat”, and the single term “shipment” to the four terms “shipment protected AWB wheat”. Submission of the combined terms from the final schema (shipment, protected, AWB, Lindberg, wheat) to the search engine produced twenty search records, of which the first three are shown below, together with the total weight of each record and the relative contributions of the terms in each record to the schema:

(0.9354) => AWB will fight very hard to ensure the Australian wheat
farmers interests are protected in the period post hostilities Mr
Lindberg said Doc_{——}979 DoW_{——}thu Date_{——}20_3_2003 MoY_{——}3
Year_{——}2003
[Thu Mar 20 00:00:00 2003, Lindberg−> 0.6847, AWB−> 0.2598,
protected−> 0.1497, wheat−> 0.0817]
(0.1711) => AWB managing director Andrew Lindberg said a different
customer might be found for the cargo Doc_{——}979 DoW_{——}thu
Date_{——}20_3_2003 MoY_{——}3 Year_{——}2003 [Thu Mar 20 00:00:00
2003,
Lindberg−> 0.62, AWB−> 0.2409]
(0.1658) => An AWB spokesman said a team of board officials had
inspected the grain shipment and it was not contaminated Doc_{——}300
DoW_{——}mon Date_{——}24_2_2003 MoY_{——}2 Year_{——}2003 [Mon Feb 24
00:00:00
2003, shipment−> 0.6682, AWB−> 0.1657]

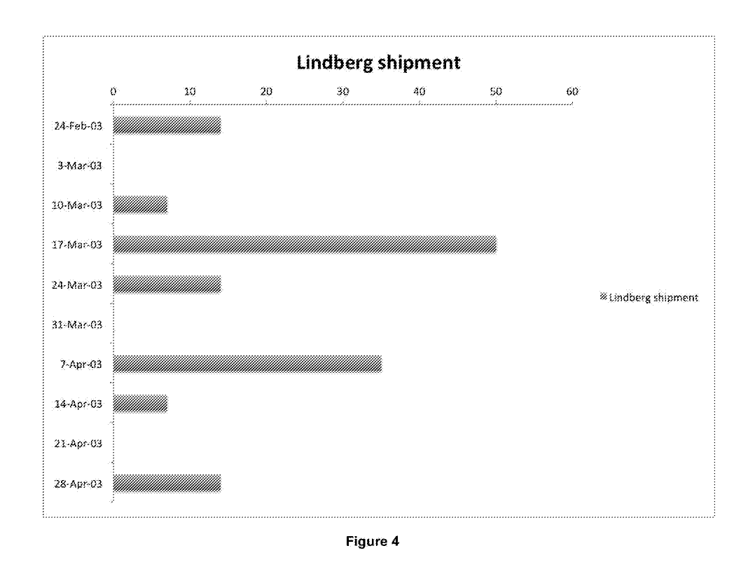

A time-based histogram of the final search hits relevant to the schema generated from the query ‘Lindberg shipment’ is shown in FIG. 4, illustrating the temporal trend of coverage of Australian wheat exports through the course of the time period before and after the invasion of Iraq. The horizontal axis units are normalised hit counts.

### EXAMPLE III

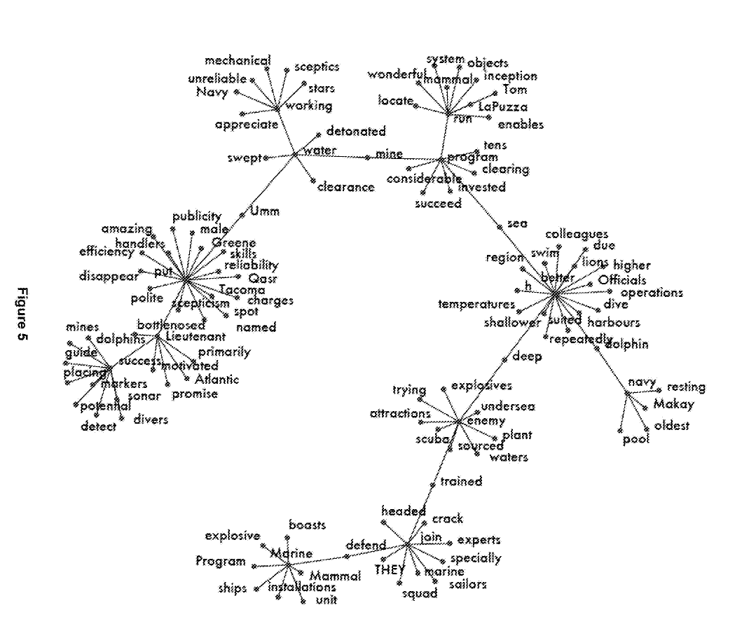

As a third example, the search query “dolphin OR dolphins” was also submitted to the search engine to the same repository of newspaper articles from 2003, and the resulting schema was used to generate the concept tree shown graphically in FIG. 5.

Many modifications will be apparent to those skilled in the art without departing from the scope of the present invention.

1. A computer implemented schema generation process, including:
receiving one or more query terms;
submitting the received query terms to a search engine;
receiving, from the search engine, search results corresponding to the submitted query terms, said search results including a plurality of search records and respective weights, each of said search records including a plurality of corresponding record terms;
processing the search records and the respective weights to generate a multi-dimensional matrix or ‘schema’ including correlation scores for respective groupings of terms selected from the query terms and/or the record terms, each of the correlation scores being representative of the co-occurrence of the terms of the corresponding grouping of terms in the search records such that the correlation scores constitute measures of the relevance of the corresponding terms.

2. The process of claim 1, wherein the record terms include terms representing metadata of the corresponding search records.

3. The process of claim 1, including selecting a subset of the terms of the schema based on corresponding correlation scores, and submitting the selected terms as enhanced query terms to the search engine.

4. The process of claim 3, including:
receiving, from the search engine, second search results corresponding to the enhanced query terms, said second search results including a plurality of second search records and respective second weights, each of said second search records including a plurality of corresponding second record terms; and
processing the second search records, respective second weights and the schema to generate second correlation scores for respective groupings of terms selected from the enhanced query terms and/or the second record terms, each second correlation score being representative of the co-occurrence of the terms of the corresponding grouping of terms in the second search records such that the second correlation scores constitute measures of the relevance of the corresponding terms, and each of the second groupings includes more terms than the groupings that were used to generate the schema.

5. The process of claim 1, including comparing said scores to a pre-determined threshold score, and selecting for processing only those terms whose scores are at least equal to or greater than the pre-determined threshold score.

6. The process of claim 1, including processing the scores to select a subset of the record terms for subsequent processing.

7. The process of claim 1, including processing the scores to select a subset of the query terms for subsequent processing.

8. The process of claim 1, including repeating at least some of the steps of the process to generate a plurality of schemas for respective different times, and processing the plurality of schemas to determine changes in the relevance of the terms over time.

9. The process of claim 1, including generating a tree structure representing relationships between said terms.

10. The process of claim 1, wherein the terms are associated with one or more corresponding concepts, and the correlation scores constitute measures of the relevance of said concepts expressed in the search records.

11. The process of claim 10, including generating a concept tree representing relationships between said concepts.

12. The process of claim 1, wherein the search records represent natural language.

13. The process of claim 1, wherein the search records represent transaction logs.

14. The process of claim 1, wherein the groupings are pairs of terms.

15. A tangible computer-readable storage medium having stored thereon executable instructions that, when executed by at least one processor of a computing system, cause the at least one processor to execute the process of claim 1.

16. A schema generation system configured to execute the process of claim 1.

17. A schema generation system, including a schema generation component configured to:
receive one or more query terms;
submit the received query terms to a search engine;
receive, from the search engine, search results corresponding to the submitted query terms, said search results including a plurality of search records and respective weights, each of said search records including a plurality of corresponding record terms;
process the search records and the respective weights to generate a multi-dimensional matrix or ‘schema’ including correlation scores for respective groupings of terms selected from the query terms and/or the record terms, each of the correlation scores being representative of the co-occurrence of the terms of the corresponding grouping of terms in the search records such that the correlation scores constitute measures of the relevance of the corresponding terms.

18. The system of claim 17, wherein the record terms include terms representing metadata of the corresponding search records.

19. The system of claim 17, wherein the schema generation component is configured to compare said scores to a pre-determined threshold score, and select for processing only those terms whose scores are at least equal to or greater than the pre-determined threshold score.

20. The system of claim 17, wherein the schema generation component is configured to process the scores to select a subset of the record terms and/or the query terms for subsequent processing.
